(19) United States
(12) Patent Application Publication
(10) Pub. No.: US 2011/0050575 A1
(43) Pub. Date: Mar. 3, 2011

(54) METHOD AND APPARATUS FOR AN ADAPTIVE TOUCH SCREEN DISPLAY

(75) Inventors: John KRAHENBUHL, McHenry, IL (US); Anant Athale, Schaumburg, IL (US)

(73) Assignee: Motorola, Inc., Schaumburg, IL (US)

(21) Appl. No.: 12/550,928

(22) Filed: Aug. 31, 2009

(51) Int. Cl. G06F 3/02; G06F 3/041

(52) U.S. Cl. 345/168; 345/173

(57) ABSTRACT

A method (200) and apparatus (100) for an adaptive touch screen display is disclosed. The apparatus can include a touch screen display (140) configured to display a virtual user interface input and configured to register proximity information regarding a proximity of a physical user input mechanism to the touch screen display. The apparatus can include a touch screen display module (191) coupled to the touch screen display. The touch screen display module can be configured to display, on the virtual user interface input, a predicted primary input item based on the proximity information and configured to display at least one alternate input item based on the proximity information while displaying the predicted primary input item.

### BACKGROUND

1. Field

The present disclosure is directed to a method and apparatus for an adaptive touch screen display. More particularly, the present disclosure is directed to an adaptive virtual user interface input on a touch screen display.

2. Introduction

Presently, portable communication devices are becoming more prevalent as users desire to keep connected with other users electronically. These portable communication devices can include cellular phones, personal digital assistants, portable digital music players, portable multimedia devices, and other portable communication devices. Many portable communication devices use touch screen displays to provide for a large viewing area on a display while maintaining compactness of the devices. The touch screen displays allow a user to input data and commands using a virtual user interface on the touch screen. For example, a touch screen display can display a virtual QWERTY keyboard to allow a user to enter text, can display a virtual media player interface to allow a user to control a media player, can display a virtual telephonic keypad to allow a user to make a call, and can display other virtual user interfaces.

Unfortunately, the compact size and portability of a portable communication device limits the size of the touch screen display. This can make it difficult for a user to accurately activate keys or buttons on a virtual user interface. For example, the keys on a virtual QWERTY keyboard can be relatively small on a portable communication device touch screen display, which can make it difficult for a user to accurately activate the desired keys on the QWERTY keyboard. Furthermore, current realizations of virtual keys on touch screen displays do not adapt to a user's individual patterns of interaction. Additionally, traditional implementations of touch virtual keys do not take into consideration individual biometrics, such as hand and finger geometry, or additional factors, such as variance of force applied, when determining target size and gesture thresholds. Also, current implementations provide minimal user interface adaptations to increase user input accuracy. These limitations result in a less-than-optimal experience.

Thus, there is a need for a method and apparatus for an adaptive touch screen display.

### SUMMARY

A method and apparatus for an adaptive touch screen display is disclosed. The apparatus can include a touch screen display configured to display a virtual user interface input and configured to register proximity information regarding a proximity of a physical user input mechanism to the touch screen display. The apparatus can include a touch screen display module coupled to the touch screen display. The touch screen display module can be configured to display, on the virtual user interface input, a predicted primary input item based on the proximity information and configured to display at least one alternate input item based on the proximity information while displaying the predicted primary input item.

### BRIEF DESCRIPTION OF THE DRAWINGS

In order to describe the manner in which advantages and features of the disclosure can be obtained, a more particular description of the disclosure briefly described above will be rendered by reference to specific embodiments thereof, which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of an apparatus according to a possible embodiment;

FIG. 2 is an exemplary flowchart illustrating the operation of an apparatus according to a possible embodiment;

FIG. 3 is an exemplary illustration of a touch screen display according to one possible embodiment;

FIG. 4 is an exemplary illustration of a touch screen display according to another possible embodiment; and

FIG. 5 is an exemplary illustration of a touch screen display according to another possible embodiment.

### DETAILED DESCRIPTION

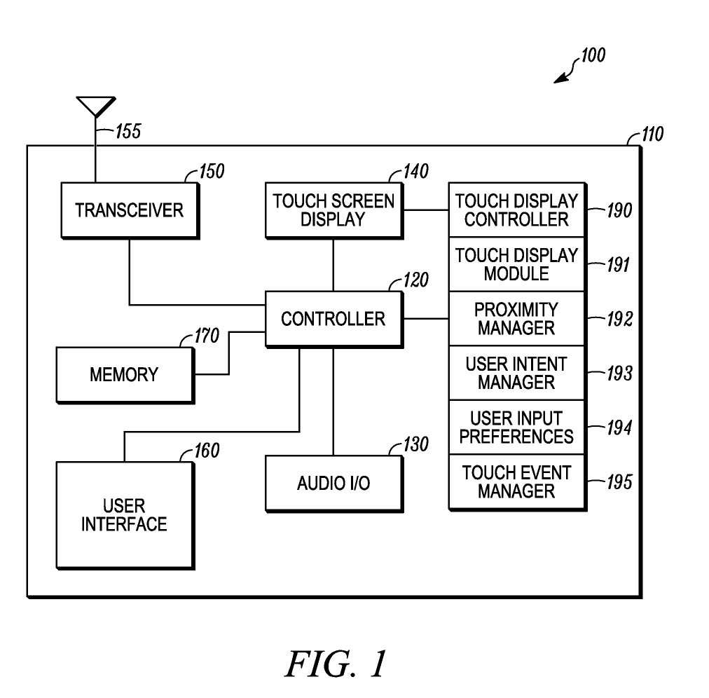

FIG. 1 is an exemplary block diagram of an apparatus 100 according to a possible embodiment. The apparatus 100 may be a portable communication device, such as a wireless telephone, a cellular telephone, a personal digital assistant, a selective call receiver, a portable device that is capable of sending and receiving communication signals on a wireless network, a portable multimedia player, a handheld music player, or any other portable communication device. The apparatus 100 may communicate on a wireless wide area network, such as a wireless telecommunications network, a cellular telephone network, a time division multiple access network, a code division multiple access network, a satellite communications network, and other like communications systems.

The apparatus 100 can include a housing 110, a controller 120 coupled to the housing 110, audio input and output circuitry 130 coupled to the housing 110, a touch screen display 140 coupled to the housing 110, a transceiver 150 coupled to the housing 110, an antenna 155 coupled to the transceiver 150, a user interface 160 coupled to the housing 110, and a memory 170 coupled to the housing 110. The apparatus 100 can also include a touch display controller 190, a touch screen display module 191, a touch screen proximity manager module 192, a user intent manager module 193, a user input preferences module 194, and a touch event manager module 195. The touch screen display module 191, the touch screen proximity manager module 192, the user intent manager module 193, the user input preferences module 194, and the touch event manager module 195 can be coupled to the controller 120, can reside within the controller 120, can reside within the memory 170, can be autonomous modules, can be software, can be hardware, or can be in any other format useful for a module on the apparatus 100.

The transceiver 150 may include a transmitter and/or a receiver. The audio input and output circuitry 130 can include a microphone, a speaker, a transducer, or any other audio input and output circuitry. The user interface 160 can include a keypad, buttons, a touch pad, a joystick, an additional display, or any other device useful for providing an interface between a user and an electronic device. The memory 170 may include a random access memory, a read only memory, an optical memory, a subscriber identity module memory, or any other memory that can be coupled to a wireless communication device.

The touch screen display 140 can be configured to display a virtual user interface input and can be configured to register proximity information regarding a proximity of a physical user input mechanism to the touch screen display 140. The touch screen display 140 can be an infrared sensor display, a capacitive array sensor display, a resistive sensor display, or any other sensor for a touch screen display. The physical user input mechanism can be a finger, a stylus, conductive activating material, or any other physical user input mechanism. The touch screen display module 191 can be configured to display, on the virtual user interface input, a predicted primary input item based on the proximity information and can be configured to display at least one alternate input item based on the proximity information while displaying the predicted primary input item.

The predicted primary input item can be a first key and the alternate input item can be a second key proximal to the first key. The touch screen display module 191 can be configured to emphasize the first key with a first emphasis based on the proximity information and can be configured to emphasize the second key with a second emphasis based on the proximity information while emphasizing the first key. For example, the keys can be emphasized using different colors, emphasized using different sizes, emphasized using different shapes, or otherwise emphasized. Also, the predicted primary input item can be a first key and the alternate input item can include a plurality of alternate input items corresponding to a plurality of alternate keys at least partially surrounding the first key on the touch screen display 140. The touch screen display module 191 can be configured to emphasize the first key with a first emphasis based on the proximity information. The touch screen display module 140 can be configured to emphasize the plurality of alternate keys with a second emphasis based on the proximity information while emphasizing the first key. The touch screen display module 191 can be configured to emphasize the plurality of alternate keys with a second emphasis while emphasizing the first key by displaying at least the plurality of alternate keys radiating from an area substantially corresponding to the proximity of the physical user input mechanism. For example, touch screen display module 191 can display a peacock tail or flower petal arrangement of keys radiating from the location of a user's finger on the touch screen display 140. The peacock tail or flower petal arrangement can include the first key along with the plurality of alternate keys. The touch screen display module 191 can also display a honeycomb pattern, can display a columbine, such as a flower petal with large and small petals, and/or can emphasize input items in any other manner.

The virtual user interface input can be a virtual QWERTY keypad, can include media player buttons, or can include other input items. The virtual user interface input can also be a numeric keypad where the predicted primary input item can be an input item associated with a key on the numeric keypad and where the alternate input item can be an input item associated with the same key as the predicted primary input item. For example, a numeric keypad can be a telephonic keypad useful for entering a phone number on a mobile phone. An input item can be a number or letter on the telephonic keypad. Thus, the predicted primary input item can be, for example, the number 2 and alternate input items can be the letters, such as A, B, and/or C, and/or punctuation associated with the same key. As another alternative, the predicted primary input item can be a letter predicted by a text messaging letter prediction algorithm and the alternate input item can be one or more other letters and/or the number associated with the same key on the telephonic keypad. The predicted primary input item and/or the alternate input items may or may not be shown on the touch screen display 140 before a user brings the physical user input mechanism into proximity with the touch screen display 140.

The touch screen display 140 can have a first axis and a second axis, where the second axis is perpendicular to the first axis. The proximity information can include first axis coordinates corresponding to the proximity of the physical user input mechanism along the first axis and second axis coordinates corresponding to the proximity of the physical user input mechanism along the second axis. For example, the first axis can be a horizontal axis, such as an x-axis, and the second axis can be a vertical axis, such as a y-axis.

The touch screen display 140 can include a touch screen display screen 140, can include a touch screen display controller 190 configured to control the touch screen display screen 140 to display a virtual user interface input, and can include a touch screen proximity manager module 192 configured to register proximity information regarding a proximity of a physical user input mechanism to the virtual user interface input. The apparatus 100 can include a user intent manager module 193 configured to determine the predicted primary input item based on the proximity information and based on a state of the virtual user interface input. For example, the user intent manager module 193 can determine the predicted primary input item based on the location of a user's finger relative to a given input item, such as a virtual key or button, on a given type of virtual interface, such as a virtual keypad, a virtual keyboard, or a virtual controller, displayed on the touch screen display 140. The user intent manager module 193 can also determine the predicted primary input item based on other information, such as an input prediction dictionary that predicts possible word entries based on letters already entered by a user. Certain areas may be off screen or not shown on the touch screen display 140. Also, an input item target size may change, which may not be reflected visually.

The apparatus 100 can include a user input preferences module 194 configured to provide user input preference information affecting the predicted primary input item and the alternate input item. The touch screen display module 191 can display the predicted primary input item and display the alternate input item on the touch screen display 140 based on the proximity information and based on the user input preference information. The apparatus 100 can include a touch event manager module 195 configured to monitor the proximity information and configured to change virtual user interface input display information based on the proximity information. The touch screen display module 191 can emphasize the predicted primary input item and emphasize the alternate input item on the touch screen display 140 based on the changed virtual user interface input display information.

According to a related embodiment, the apparatus 100 can include a portable communication device housing 110. The apparatus 100 can include a touch screen display 140 coupled to the portable communication device housing 110. The touch screen display 140 can be configured to display a virtual user interface input including a first virtual key and a second virtual key proximal to the first virtual key. The touch screen display 140 can be configured to register proximity information regarding a proximity of a finger of a user to the touch screen display 140. The apparatus 100 can include a touch screen display module 191 coupled to the touch screen display 140. The touch screen display module 191 can be configured to visually emphasize, on the virtual user interface input, the first virtual key with a first emphasis based on the proximity information and configured to visually emphasize, on the virtual user interface input, the second virtual key with a second emphasis based on the proximity information while visually emphasizing the first virtual key on the virtual user interface input. The touch screen display module 191 can also be configured to visually emphasize the second virtual key with a second emphasis while visually emphasizing the first virtual key with the first emphasis by displaying the first virtual key and the second virtual key radiating from an area substantially corresponding to the proximity of the finger.

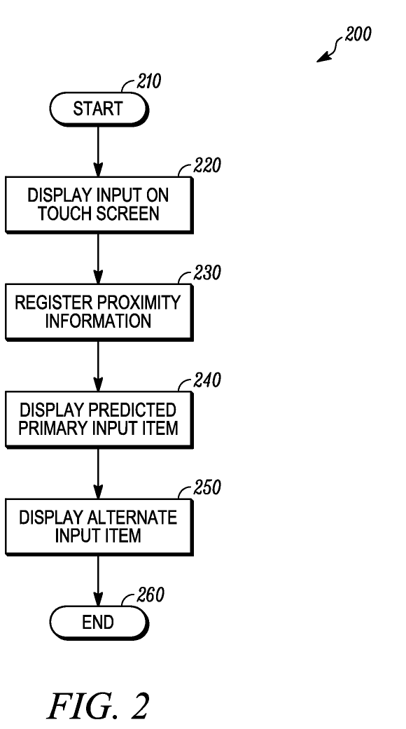

FIG. 2 is an exemplary flowchart 200 illustrating the operation of an apparatus, such as the apparatus 100, according to a possible embodiment. At 210, the flowchart begins. At 220, a virtual user interface input can be displayed on a touch screen display. At 230, proximity information regarding a proximity of a physical user input mechanism to the touch screen display can be registered. At 240, a predicted primary input item can be displayed on the virtual user interface input based on the proximity information. At 250, at least one alternate input item can be displayed on the virtual user interface input based on the proximity information while displaying the predicted primary input item.

The predicted primary input item can be a first key and the at least one alternate input item can be a second key proximal to the first key. The predicted primary input item can be displayed by emphasizing the first key with a first emphasis based on the proximity information. The at least one alternate input item can be displayed by emphasizing the second key with a second emphasis based on the proximity information while emphasizing the first key. Also, the predicted primary input item can be a first key and the at least one alternate input item can include a plurality of alternate input items corresponding to a plurality of alternate keys at least partially surrounding the first key. The predicted primary input item can be displayed by emphasizing the first key with a first emphasis based on the proximity information. The at least one alternate input item can be displayed by emphasizing the plurality of alternate keys with a second emphasis based on the proximity information while emphasizing the first key. The plurality of alternate keys can be emphasized with a second emphasis while emphasizing the first key by displaying at least the plurality of alternate keys radiating from an area substantially corresponding to the proximity of the physical user input mechanism.

The touch screen display can have a first axis and a second axis, where the second axis is perpendicular to the first axis. The proximity information can include first axis coordinates corresponding to the proximity of the physical user input mechanism along the first axis and second axis coordinates corresponding to the proximity of the physical user input mechanism along the second axis.

The virtual user interface input can be a virtual QWERTY keypad, can be another type of keypad, can be a media player virtual interface, or can be any other virtual user interface input. For example, the virtual user interface input can also be a numeric keypad where the predicted primary input item can be an input item associated with a key on the numeric keypad and where the alternate input item can be an input item associated with the same key as the predicted primary input item. In step 260, the flowchart 200 ends.

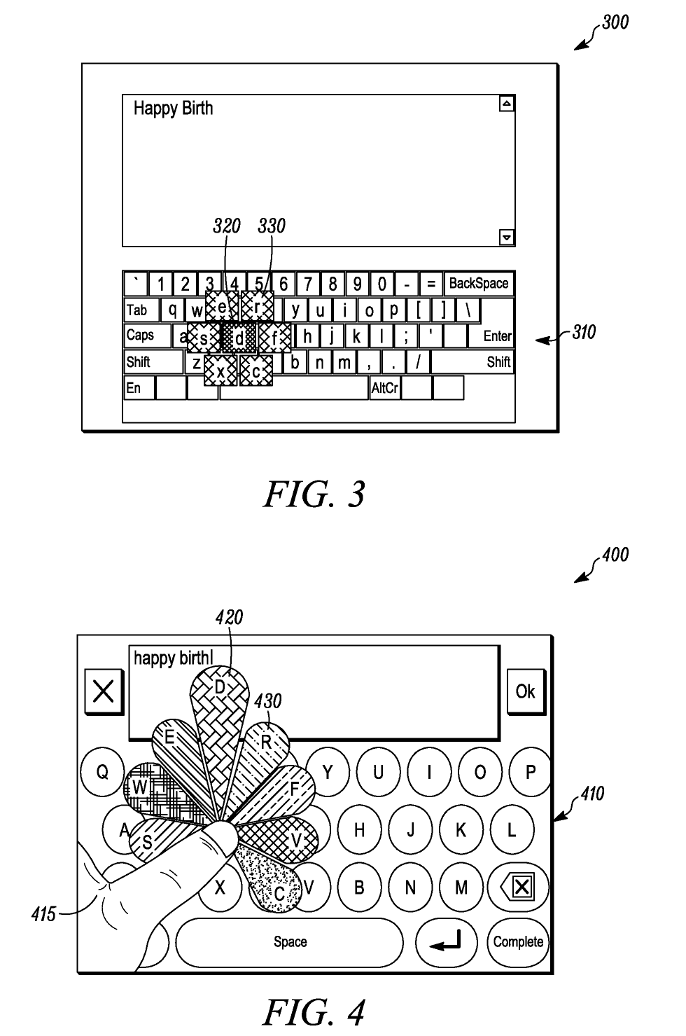

FIG. 3 is an exemplary illustration of a touch screen display 300, such as the touch screen display 140, according to one embodiment. The touch screen display 300 can include a virtual user interface input 310, such as a virtual QWERTY keypad. A predicted primary input item 320 can be displayed and emphasized on the virtual user interface input 310 based on proximity information. At least one alternate input item 330 can be displayed and emphasized on the virtual user interface input 310 based on the proximity information while displaying the predicted primary input item 320.

FIG. 4 is an exemplary illustration of a touch screen display 400, such as the touch screen display 140, according to another embodiment. The touch screen display 400 can include a virtual user interface input 410, such as a virtual QWERTY keypad. Proximity information regarding a proximity of a physical user input mechanism 415, such as a user's finger, to the touch screen display 400 can be registered. A predicted primary input item 420 can be displayed and emphasized on the virtual user interface input 410 based on the proximity information. At least one alternate input item 430 can be displayed and emphasized on the virtual user interface input 410 based on the proximity information while displaying the predicted primary input item 420. For example, a peacock tail or flower petal arrangement of keys 420 and 430 can be displayed radiating from the location of the user's finger 415 on the touch screen display 400. The peacock tail or flower petal arrangement can include the first key 420 along with a plurality of alternate keys including the key 430.

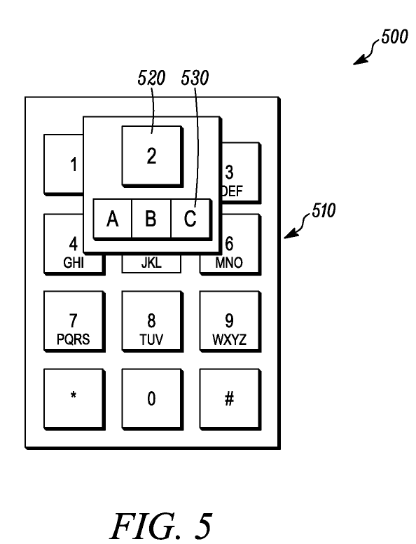

FIG. 5 is an exemplary illustration of a touch screen display 500, such as the touch screen display 140, according to another embodiment. The touch screen display 500 can include a virtual user interface input 510, such as a telephonic numeric keypad. A predicted primary input item 520 can be displayed and emphasized on the virtual user interface input 510 based on proximity information. At least one alternate input item 530 can be displayed and emphasized on the virtual user interface input 510 based on the proximity information while displaying and emphasizing the predicted primary input item 520.

Embodiments can provide for an apparatus and method that leverages information provided by user preferences, hardware sensors, and/or other mechanisms to adapt the sensitivity of a touch sensor display and associated user interface elements as recommended by an adaptive touch engine. Touch sensor display sensitivity, target sizes, and corresponding associative user interface elements can be dynamically adapted. This adaptable human computer interaction model can increase user accuracy and provide an optimized user experience.

Embodiments can provide for a proximity manager that gathers proximity data, such as x and y coordinates, from a proximity sensor to determine a user-intended touch region. A user intent manager can translate the proximity data, information about a virtual touch interface application state, and language dictionary services, such as predictive text, to accurately calculate a user's intent. The user's intent can then be translated into corresponding proximity/pseudo-touch events to be handled by applications on the apparatus. User preferences can be taken into account to determine an appropriate adaptation. The nature and extent of the changes to the user interface can be user controllable to improve usability. The user preferences can be persistent and can be communicated to a pseudo-touch event manager. A pseudo-touch event manager module can register with the proximity manager and can be responsible for handling proximity events relevant to a virtual user interface application. In a model-view-controller based user interface framework, these events can be handled by a controller layer. A view on the touch screen display can then be adapted to accommodate changes in layout, target sizes, colors, etc. for the virtual user interface. As an example, the user interface adaptation involving re-layout, resize, recolor, etc. can be accomplished via style sheets. The proximity events can be continuously monitored and the user interface changes can be applied to the layout, target sizes, colors, etc.

Embodiments can make appropriate user interface adaptations based on user preferences, patterns of interaction, and language engines, such as predictive text, to optimize a user's interaction with a virtual user interface or any virtual key on a given surface, such as a single-touch or multi-touch touch screen display.

The methods of this disclosure may be implemented on a programmed processor. However, the operations of the embodiments may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the operations of the embodiments may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure. In this document, relational terms such as “first,” “second,” and the like may be used solely to distinguish one entity or action from another entity or action without necessarily requiring or implying any actual such relationship or order between such entities or actions. Also, relational terms, such as “top,” “bottom,” “front,” “back,” “horizontal,” “vertical,” and the like may be used solely to distinguish a spatial orientation of elements relative to each other and without necessarily implying a spatial orientation relative to any other physical coordinate system. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. An apparatus comprising:
a touch screen display configured to display a virtual user interface input and configured to register proximity information regarding a proximity of a physical user input mechanism to the touch screen display; and
a touch screen display module coupled to the touch screen display, the touch screen display module configured to display, on the virtual user interface input, a predicted primary input item based on the proximity information and configured to display at least one alternate input item based on the proximity information while displaying the predicted primary input item.

2. The apparatus according to claim 1,
wherein the predicted primary input item comprises a first key and the alternate input item comprises a second key proximal to the first key, and
wherein the touch screen display module is configured to emphasize the first key with a first emphasis based on the proximity information and emphasize the second key with a second emphasis based on the proximity information while emphasizing the first key.

3. The apparatus according to claim 1,
wherein the predicted primary input item comprises a first key and the alternate input item comprises a plurality of alternate input items corresponding to a plurality of alternate keys at least partially surrounding the first key on the touch screen display,
wherein the touch screen display module is configured to emphasize the first key with a first emphasis based on the proximity information, and
wherein the touch screen display module is configured to emphasize the plurality of alternate keys with a second emphasis based on the proximity information while emphasizing the first key.

4. The apparatus according to claim 3, wherein the touch screen display module is configured to emphasize the plurality of alternate keys with a second emphasis while emphasizing the first key by displaying at least the plurality of alternate keys radiating from an area substantially corresponding to the proximity of the physical user input mechanism.

5. The apparatus according to claim 1, wherein the virtual user interface input comprises a virtual QWERTY keypad.

6. The apparatus according to claim 1,
wherein the touch screen display has a first axis and a second axis, where the second axis is perpendicular to the first axis, and
wherein the proximity information comprises first axis coordinates corresponding to the proximity of the physical user input mechanism along the first axis and second axis coordinates corresponding to the proximity of the physical user input mechanism along the second axis.

7. The apparatus according to claim 1, wherein the touch screen display comprises:
a touch screen display screen;
a touch screen display controller configured to control the touch screen display screen to display the virtual user interface input; and
a touch screen proximity manager module configured to register proximity information regarding a proximity of a physical user input mechanism to the virtual user interface input.

8. The apparatus according to claim 1, further comprising a user intent manager module configured to determine the predicted primary input item based on the proximity information and based on a state of the virtual user interface input.

9. The apparatus according to claim 1, further comprising a user input preferences module configured to provide user input preference information affecting the predicted primary input item and the alternate input item,
wherein the touch screen display module is configured to display the predicted primary input item and display the alternate input item on the touch screen display based on the proximity information and based on the user input preference information.

10. The apparatus according to claim 1, further comprising a touch event manager module configured to monitor the proximity information and configured to change virtual user interface input display information based on the proximity information,
wherein the touch screen display module is configured to emphasize the predicted primary input item and emphasize the alternate input item on the touch screen display based on the changed virtual user interface input display information.

11. The apparatus according to claim 1,
wherein the virtual user interface input comprises a numeric keypad,
wherein the predicted primary input item comprises an input item associated with a key on the numeric keypad, and
wherein the alternate input item comprises an input item associated with the same key as the predicted primary input item.

12. A method comprising:
displaying a virtual user interface input on a touch screen display;
registering proximity information regarding a proximity of a physical user input mechanism to the touch screen display;
displaying, on the virtual user interface input, a predicted primary input item based on the proximity information; and
displaying, on the virtual user interface input, at least one alternate input item based on the proximity information while displaying the predicted primary input item.

13. The method according to claim 12,
wherein the predicted primary input item comprises a first key and the at least one alternate input item comprises a second key proximal to the first key,
wherein displaying the predicted primary input item comprises emphasizing the first key with a first emphasis based on the proximity information; and
wherein displaying at least one alternate input item comprises emphasizing the second key with a second emphasis based on the proximity information while emphasizing the first key.

14. The method according to claim 12,
wherein the predicted primary input item comprises a first key and the at least one alternate input item comprises a plurality of alternate input items corresponding to a plurality of alternate keys at least partially surrounding the first key,
wherein displaying the predicted primary input item comprises emphasizing the first key with a first emphasis based on the proximity information, and
wherein displaying at least one alternate input item comprises emphasizing the plurality of alternate keys with a second emphasis based on the proximity information while emphasizing the first key.

15. The method according to claim 14, wherein emphasizing the plurality of alternate keys comprises emphasizing the plurality of alternate keys with a second emphasis while emphasizing the first key by displaying at least the plurality of alternate keys radiating from an area substantially corresponding to the proximity of the physical user input mechanism.

16. The method according to claim 12, wherein the virtual user interface input comprises a virtual QWERTY keypad.

17. The method according to claim 12,
wherein the touch screen display has a first axis and a second axis, where the second axis is perpendicular to the first axis, and
wherein the proximity information comprises first axis coordinates corresponding to the proximity of the physical user input mechanism along the first axis and second axis coordinates corresponding to the proximity of the physical user input mechanism along the second axis.

18. The method according to claim 12,
wherein the virtual user interface input comprises a numeric keypad,
wherein the predicted primary input item comprises an input item associated with a key on the numeric keypad, and
wherein the alternate input item comprises an input item associated with the same key as the predicted primary input item.

19. An apparatus comprising:
a portable communication device housing;
a touch screen display coupled to the portable communication device housing, the touch screen display configured to display a virtual user interface input including a first virtual key and a second virtual key proximal to the first virtual key, and configured to register proximity information regarding a proximity of a finger of a user to the touch screen display; and
a touch screen display module coupled to the touch screen display, the touch screen display module configured to visually emphasize, on the virtual user interface input, the first virtual key with a first emphasis based on the proximity information and configured to visually emphasize, on the virtual user interface input, the second virtual key with a second emphasis based on the proximity information while visually emphasizing the first virtual key on the virtual user interface input.

20. The apparatus according to claim 19, wherein the touch screen display module is configured to visually emphasize the second virtual key with a second emphasis while visually emphasizing the first virtual key with the first emphasis by displaying the first virtual key and the second virtual key radiating from an area substantially corresponding to the proximity of the finger.
